(19) United States
(12) Patent Application Publication
(10) Pub. No.: US 2007/0263493 A1
(43) Pub. Date: Nov. 15, 2007

(54) Video game disc changer

(76) Inventor: David Thomas Rodgers, Medford, OR (US)

Correspondence Address: David Rodgers, 527 EFFIE, Medford, OR, 97504, US

(21) Appl. No.: 11/507,299

(22) Filed: Aug. 22, 2006

Related U.S. Application Data
(60) Provisional application No. 60/786,021, filed on Mar. 27, 2006.

(51) Int. Cl. G11B 17/22

(52) U.S. Cl. 369/30.64

(57) ABSTRACT

The Video game disc changer is device that allows people to switch games with remote from across the room instead of doing it manually. You put your favorite 5 to 10 in it and play. This makes it easier to keep track of you games, keep them from getting damaged, and help you relax. This is the first time anyone has will have disc changer that can do this.

This referrers to the provisional application No. 60/786,021 filed on Mar. 27, 2006. My invention is the video Game Disc Changer. It is a compartment that stores games and other media discs. Controlled by remote this device gives gamers the ability store all their favorite games movies and cd's in one compartment. This will prevent problems of loosing discs, because you can now store your favorite 5 to 10 discs in the compartment. The video game disc changer will also resolve the problem of discs getting damaged, by keeping them in this protective case. This invention can be useful to those who have mobile disabilities and cannot easily get up and change them. Many Americans have become accustom the television remote in order to not have to get up and change the channel, so to this disc changer will be desirable to those who want to relax in the same way.

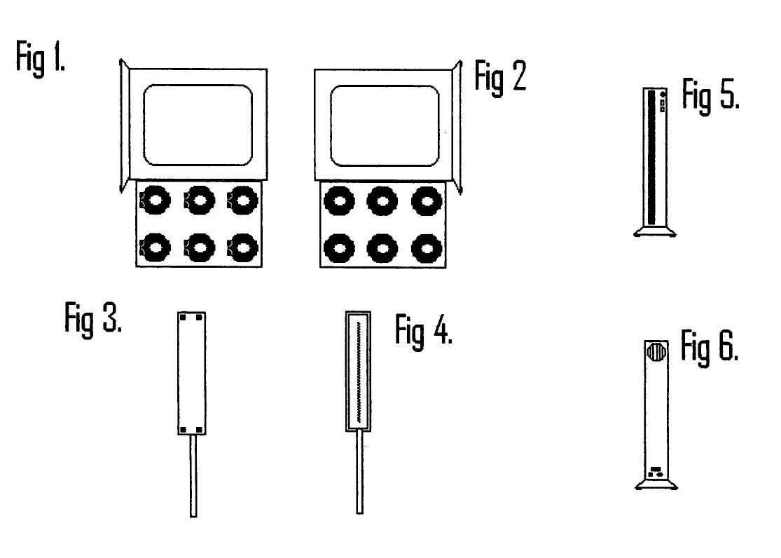

A brief description of several views of the drawings. 0002 the drawing given shows all six sides of the invention. Figure one shows the main side if you will. Notice it has a stand to hold the unit upright. Also figure one shows a rectangular tray that has six slots. There are notches on the slots to keep the disc stationary when unit is up right. Figure two shows the opposite side of the unit. The dark rings are just showing the indentation of the tray. FIG. 3 shows the bottom of the object the black squares are rubber pads that keep the unit from sliding. FIG. 4 shows the top of the object there is nothing significant hears. Figure five shows the front of the unit the long back rectangle is the disc tray. The black cross shaped object is the remote sensor. The other two objects are buttons just in case you loose the remote. Figure six shows the back of it the round object with black lines in it is the fan, to cool down the unit. The other objects at the bottom are cord ports, to do things like power the unit and hook it up to a computer or T.V. 0003 this invention is different because, it is the first time anyone made a disc changer for video games. Other than that it is the same thing you have under your car seat, or in your house to change your CD's. To make it a little different, I made it so that the electronic eye moves around the bottom of the tray on rails. But it could be used to where the discs rotate around the eye itself.

1. What I claim as my invention is a multiple video game disc changer.
